(19) United States
(12) Patent Application Publication
(10) Pub. No.: US 2008/0110812 A1
(43) Pub. Date: May 15, 2008

(54) SEPARATED WATER TREATMENT SYSTEM FOR DIESEL FUEL ENGINE

(75) Inventors: Hans Jensen, West Bloomfield, MI (US); Zhouxuan Xia, Windsor (CA); Kevin Mulkeran, Holly, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Mahle Tennex Industries, Inc.

(21) Appl. No.: 11/760,443

(22) Filed: Jun. 8, 2007

Related U.S. Application Data
(60) Provisional application No. 60/858,533, filed on Nov. 13, 2006.

(51) Int. Cl. B01D 17/00; F17D 1/08

(52) U.S. Cl. 210/143; 137/1

(57) ABSTRACT

A method for treating water separated from diesel fuel, and a diesel fuel filter or water trap for a fuel water collection system are disclosed. A water trap may generally include a primary reservoir, a drain in fluid communication with the primary reservoir, and a controller for the drain that is operable to selectively exhaust a quantity of water from the primary reservoir to one or more water treatment locations located on the vehicle. A method of removing water from a fuel may generally include accumulating a quantity of water removed from a fuel supply in a primary reservoir, selectively draining a portion of the quantity of water from the primary reservoir, and receiving the portion of the quantity of water at a water treatment location in a vehicle.

### CROSS-REFERENCE TO RELATED APPLICATIONS

This application claims priority based on U.S. Provisional Patent Application No. 60/858,533, filed Nov. 13, 2006, which is incorporated herein by reference in its entirety.

### BACKGROUND

Water may naturally accumulate in hydrocarbon fuels through a number of known mechanisms. For example, water vapor may condense in fuel stored in a closed tank for an extended period of time. Water may also accumulate in hydrocarbon fuels during transportation from refineries to service stations.

Water accumulation can cause a variety of problems for internal combustion engines, and other vehicle systems. For example, water can cause corrosion of fuel injector nozzles and fuel pumps, growth of microorganisms within a fuel system, and plugging of fuel filters with by-products of the corrosion or microbial growth. In colder weather, ice formation in fuels containing water can create severe fuel line and filter plugging problems.

Water accumulation is especially problematic for diesel engines. Diesel engines typically employ fuel injectors having tiny orifices. During operation, fuel is forced through these orifices at extremely high pressures. These orifices must be designed to very fine tolerances as a result of the high pressure environment in which they are used, as well as the great effect small variances in orifice size can have on fuel injection pressure. Accordingly, any corrosion or microorganism growth can cause severe efficiency and reliability problems for an engine.

Various methods have been developed for removing accumulated water from hydrocarbon fuels. However, water collected from hydrocarbon fuels typically must be stored on board a vehicle until the water can be removed, typically by service personnel. If water is not removed regularly, water removal systems can become backlogged, inhibiting further collection of accumulated water from the fuel system. Accordingly, there is a need for an improved system for removing accumulated water from a hydrocarbon fuel.

### SUMMARY

Various examples directed to a water trap for a fuel water collection system and a method of removing water from fuel are disclosed herein. An illustrative example of a water trap generally includes a primary reservoir, a drain in fluid communication with the primary reservoir, and a controller for the drain that is operable to selectively exhaust a quantity of water from the primary reservoir to a water treatment location located on the vehicle.

An illustrative example of a method generally includes accumulating a quantity of water removed from a fuel supply in a primary reservoir, selectively draining a portion of the quantity of water from the primary reservoir; and receiving the portion of the quantity of water at a water treatment location in a vehicle.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 is a schematic representation of an exemplary fuel water treatment system;

FIG. 2 is a section view of an exemplary water trap; and

FIG. 3 is a process flow diagram for treating various vehicle components with water removed from a fuel.

### DETAILED DESCRIPTION

Reference in the specification to “an exemplary illustration”, and “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

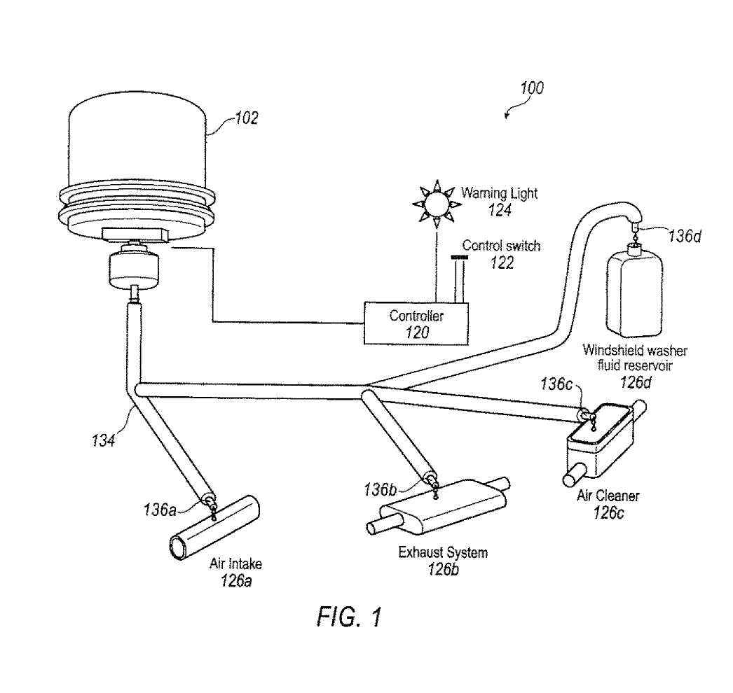

Turning now to FIG. 1, a fuel water treatment system 100 is illustrated. System 100 generally includes a diesel fuel filter or water separator 102, a controller 120, and one or more vehicular treatment locations 126a,b,c,d (collectively, 126). Water separator 102 may generally filter a diesel fuel supply to an engine (not shown), or may accumulate water removed from a hydrocarbon fuel supply, and distributes the water to various treatment locations 126. Controller 120 may automatically initiate selective distribution of accumulated water to treatment locations 126, or a manual distribution mechanism may be employed wherein water is distributed according to initiation by a user. Water treatment locations may include any location on the vehicle that is convenient. For example, vehicular treatment locations may include, for example, an air intake 126a, an exhaust system 126b, an air cleaner 126c or a windshield washer fluid reservoir 126d, as will be described in more detail below. Selective distribution of the water may be beneficial for one or more of the vehicular treatment locations. For example, water may be employed to reduce a surface temperature of any part of a vehicular exhaust system, thereby reducing the thermal load of an associated heat shield. Additionally, water may fill a windshield washer fluid reservoir, reducing maintenance intervals for re-filling the reservoir. Further, disposal of water to any of the various water treatment locations may generally reduce a need for service personnel to regularly exhaust or remove water filtered out of a fuel supply. Water trap 102 may be in fluid communication with the various vehicular treatment locations via a network of water passages 134.

Water trap 102 may be part of a diesel fuel filtering or conditioning module in a vehicle, and is generally operable to separate and/or accumulate water from a hydrocarbon fuel, e.g., diesel fuel, via any known mechanism for separating water from a fuel supply (not shown). For example, water trap 102 may employ a hydrophobic media (not shown), which generally screens water molecules and/or contaminants contained within a hydrocarbon fuel. The hydrophobic media may be placed transverse to a fuel flow, such that fuel flows through the hydrophobic media while water molecules are retained by the hydrophobic media. The screened water may then descend and accumulate in the bottom of a reservoir for removal, as a result of water's greater density than the fuel. Other contaminants may also be screened from the fuel flow, and descend toward the bottom of a reservoir. Further, water trap 102 may include any other known devices for collecting water contained in a fuel.

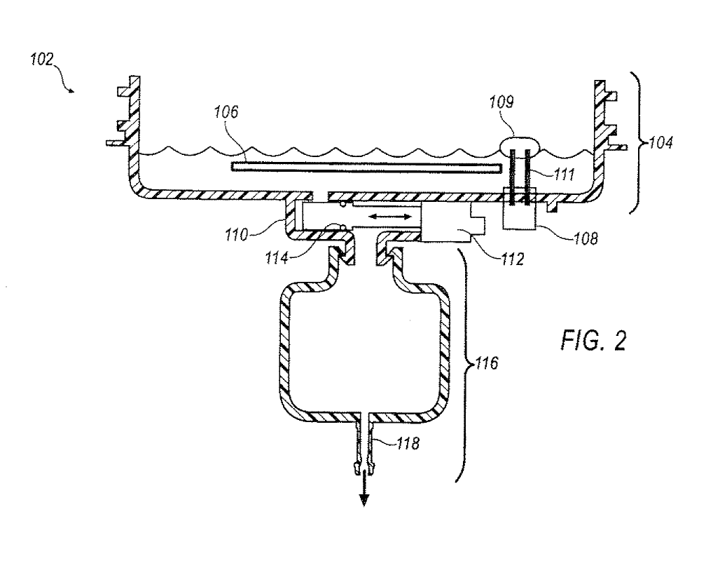

Turning now to FIG. 2, water trap 102 is shown in further detail. Water trap 102 may include a primary reservoir 104, a drain 110, and a secondary reservoir 116. Primary reservoir 104 may accumulate water from a fuel supply, either through a water separation mechanism, e.g., hydrophobic media, contained within primary reservoir 104 or elsewhere in a vehicle. Primary reservoir 104 may be of any construction that is convenient. For example, primary reservoir 104 may be formed by any known plastic forming processes, e.g., molded or blow molded from a plastic material.

Water trap 102 may further include a heating element 106. Heating element 106 is generally operable to supply heat to accumulated water and/or contaminants removed from the fuel to prevent freezing or hardening of the contaminants removed within water trap 102. While a heating element 106 is shown, other heating mechanisms may also be used, such as application of waste heat from a vehicle operation (e.g., from combustion of the hydrocarbon fuel). Heating element 106 may also generally heat fuel to prevent undesirable changes in composition that may be caused by extremely cold temperatures.

Water trap 102 may further include a water level sensor 108. Water level sensor 108 may include any mechanism for detecting an amount of water contained within primary reservoir 104. For example, water level sensor 108 may include a float 109 attached to an actuating arm 111. Water level sensor may thus determine an amount of water contained within primary reservoir 104 by a position of actuating arm 111, which moves according to a position of float 109. Any other known mechanism for detecting a level of water present within primary reservoir 104, and/or indicating a level of water within primary reservoir 104 may be employed. For example, a water pressure sensor may be utilized in place of water level sensor 108. Further, water trap 102 may include other sensors useful in the operation of a water collection device. For example, water trap 102 may employ a water temperature sensor (not shown) for determining when the heating mechanism, such as heating element 106, should be actuated to prevent freezing or hardening of water and/or contaminants contained within primary reservoir 104. Additionally, water trap 102 may include devices for detecting various fuel conditions, e.g., fuel density, fuel temperature, etc., that may be desirably communicated to controller 120.

Water trap 102 also includes a drain 110. Drain 110 is generally operable to allow water to drain out of primary reservoir 104. Drain 110 may be advantageously located at or near a bottom surface of primary reservoir 104, such that gravity promotes the flow of water out of primary reservoir 104 when drain 110 is opened. Drain 110 may include any mechanism for draining water from primary reservoir 104. For example, drain 110 may include a solenoid valve or other actuator 112. Solenoid valve 112 may shift in two directions according to actuation of an electromagnet (not shown), as is generally known. Each direction may correspond to opening or closing drain 110, respectively. To improve the effectiveness of solenoid valve 112, solenoid valve 112 may be provided with an o-ring seal 114 disposed about a perimeter of solenoid valve 112. O-ring seal 114 may generally ensure a seal between solenoid valve 112 and a drain passageway in which solenoid valve 112 is disposed. O-ring seal 114 thereby prevents water from escaping from primary reservoir 104 when solenoid valve 112 is closed, as shown in FIG. 2.

Water trap 102 may further include a secondary reservoir 116. Secondary reservoir 116 may be in fluid communication with primary reservoir 104 via drain 110, and water passages 134. Accordingly, when water is drained from primary reservoir 104, water flows into secondary reservoir 116 for distribution to any of the various water treatment locations 126 through water passages 134. Secondary reservoir 116 preferably includes a secondary drain aperture 118 which is appropriately sized to meter the flow of water out of secondary reservoir 116 and to the various water treatment locations. The flow of water out of secondary reservoir 116 thus may allow gradual exhaustion of the entire quantity of water within secondary reservoir 116, such that any one of the water treatment locations 126 is not flooded with water directly from primary reservoir 104.

Turning back to FIG. 1, system 100 is described in further detail. One or more vehicle treatment locations 126 may receive water exhausted from water trap 102. For example, an air intake 126a may receive water from water trap 102, which may be injected as droplets into the air intake stream, thereby vaporizing the water droplets. As an alternative or in addition to air intake 126a, a surface of an exhaust system or component 126b, e.g., an exhaust pipe, muffler, manifold, catalytic converter, etc., may receive water from water trap 102. Droplets of water received from water trap 102 may generally be vaporized by application to an exhaust system 126b, which may generally become very hot during operation, in some instances generally vaporizing water applied to exhaust system 126b. Another example of a treatment location 126 is an air cleaner 126c. Droplets of water received from water trap 102 may be supplied to air cleaner 126c, such that, similar to air intake 126a, small droplets of water are generally vaporized within air cleaner 126c. As a further example of a vehicular treatment location, a windshield washer fluid reservoir 126d may receive water from water trap 102. Windshield washer fluid reservoir 126d generally contains an aqueous solution of windshield washer fluid for use by the vehicle in cleaning various surfaces of a vehicle, e.g., a windshield. Accordingly, water from water trap 102 may be exhausted to windshield bottle 126d, especially, for example, when an exhaust or muffler surface is not yet hot enough to rapidly evaporate water received from water trap 102. Any other vehicle systems may receive water from water trap 102. This may be particularly convenient for vehicle systems requiring a supply of water for operation, e.g., vehicle engine cooling systems, etc. Further, in addition to water treatment locations 126, water exhausted from water trap 102 may be dumped outside a vehicle, e.g., onto a parking lot or other allowed locations and/or surfaces around or below the vehicle.

As described above, system 100 may include a plurality of water passages 134 for distributing water from water trap 102 to treatment locations 126. Water passages 134 may employ any known mechanism for drawing water through the water passages 134, such as a pump or vacuum. For example, water passages 134 may employ a capillary mechanism that generally draws water out of water trap 102 to treatment locations 126. In examples employing a capillary mechanism, water passages 134 may include a material (not shown), e.g., cotton fiber, that extends along a length of water passages 134, and generally draws water along the material by a capillary effect, wherein water will tend to flow along the material from an area having greater moisture to an area having less moisture. Water passages 134 may alternatively or additionally rely on gravity to pull water from water trap 102 through water passages 134. For example, water trap 102 may be mounted in a vehicle at a height generally above a treatment location 126 to promote flow of water out of water trap 102 along water passages 134. Further, water passages 134 may rely on low-pressure areas typical in most vehicles for drawing water through passages 134. For example, connection of water passages 134 with air intake 126a will tend to draw water toward air intake 126a, as a result of the intake vacuum typically present in the intake manifold of an internal combustion engine. As another example, low-pressure areas that naturally occur due to vehicle aerodynamics may be used to draw water through water passages 134. For example, an aperture may be provided in a water passage 134 near a rearward area of the vehicle exterior. As the vehicle travels forward during normal operation, a low pressure area will generally tend to develop around the rear of the vehicle as a result of the vehicle “pushing” air out of the way as it travels forward. The low-pressure area will tend to draw water from water trap 102 toward the aperture. The aperture may be anywhere in water passage 134 where it may be desirable to draw water to, such as adjacent or downstream of a water treatment location 126. Accordingly, water will be drawn to a water treatment location 126 as the low-pressure area develops when the vehicle is in motion. Any other known low-pressure area of a vehicle may be used in conjunction with an aperture in water passages 134 to draw water to particular areas of water passages 134 and/or water treatment locations 126. Water passages 134 preferably are provided with an appropriately sized tip 136a,b, c, d (collectively 136) near each water treatment location 126. Tips 136 are preferably sized to provide water in increments that are easily evaporated or disposed of by each particular treatment location 126.

As described above, system 100 generally includes a controller 120, which may be operable to automatically drain water from primary reservoir 104, and supply drained water to one or more treatment locations 126. For example, controller 120 may include any electronic control unit (ECU) of a vehicle, such as an engine control module, powertrain control module, etc. Controller 120 may be in communication with heating element 106, water level sensor 108, drain 110, and/or any other sensors disposed within or in communication with primary reservoir 104. Controller 120 may include logic for determining when to drain water from primary reservoir 104. For example, controller 120 may be programmed to drain water from primary reservoir 104 to maintain a predetermined water level within primary reservoir 104. Controller 120 may be in further communication with any of the treatment locations 126, and may further include logic for supplying water from primary reservoir 104 when any one of the water treatment locations requires water. For example, controller 120 may initiate solenoid valve 112 to drain water from water trap 102 and supply the drained water to windshield washer fluid reservoir 126d when windshield washer fluid reservoir 126d is nearly out of washer fluid. Where multiple water treatment locations are provided in a single system, controller 120 may further control one or more shutoff valves located in water passages 134 to properly route the flow of water to one or more desired treatment locations 126. For example, controller 120 may route water to windshield washer fluid reservoir 126d upon vehicle startup, when an exhaust system or component 126b has not yet reached a temperature effective for vaporizing water droplets. Controller 120 may subsequently route water to exhaust system 126b after the exhaust system 126b has reached a desired operating temperature. Where water passages 134 employ a material to provide a capillary effect, a capillary material disposed inside of one or more water passages 134 may be shifted or moved toward a desired treatment location, thereby allowing water to flow along the material to the desired treatment location 126 determined by controller 120. Controller 120 may alternatively or additionally include any known mechanical devices or systems for draining water from water trap 102. For example, a weight-sensitive system, which automatically drains water from primary reservoir 104 when primary reservoir 104 contains a certain amount, i.e, a certain weight, of water, may be employed.

Controller 120 may further include logic and/or a mechanism for draining water from water trap 102 in response to actuation by a user. Accordingly, a user may selectively drain water from primary reservoir 104, such as prior to storing the vehicle for an extended period of time. In examples where controller 120 includes logic or a mechanism allowing a user to drain water from primary reservoir 104, a control switch 122 may be provided for signaling controller 120 to drain water from primary reservoir 104. Alternatively, a mechanical drain actuator disposed on primary reservoir 104 may be provided for manually draining primary reservoir 104.

System 100 may additionally include a warning display 124 for generally notifying a user that water trap 102 has reached a predetermined water level, e.g., that water trap 102 is nearly full. Accordingly, warning display 124 may be in communication with controller 120 and/or water level sensor 108.

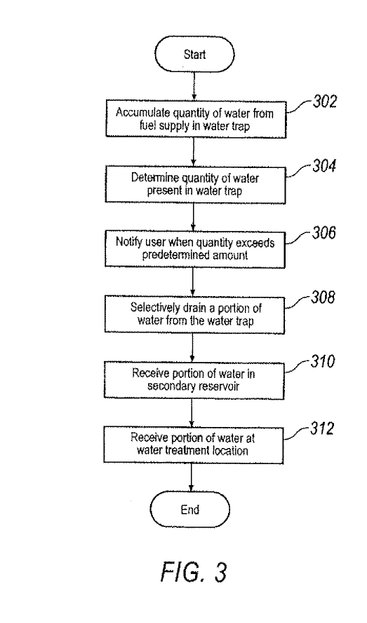

Turning now to FIG. 3, a process 300 for treating various vehicle components with water removed from a fuel is illustrated. Process 300 may generally begin at step 302 where a quantity of water accumulates in water trap 102, e.g., within primary reservoir 104, after removal from a fuel supply. For example, as described above, water trap 102 may generally include any known mechanisms for removing water from a fuel flow, e.g., hydrophobic media. In one known example, process 300 then proceeds to step 304.

In step 304, controller 120 or water level sensor 108 may determine a quantity of water present in water trap 102. For example, as described above, water level sensor 108 may detect a level of water within primary reservoir 104. The quantity of water determined in this step may be used by controller 120 as part of logic determining when to drain water from primary reservoir 104. In one known example, process 300 then proceeds to step 306.

In step 306, a user is notified that a quantity of water contained within water trap 102 exceeds a predetermined amount. For example, controller 120 may be provided with logic to notify the user via warning display 124 when primary reservoir 104 is nearly full, and should be at least partially drained. Process 300 may then proceed to step 308.

In step 308, a portion of the water contained within water trap 102 is selectively drained. For example, controller 120 may open and subsequently close a solenoid valve 112 to allow a quantity of water to drain from primary reservoir 104 to secondary reservoir 116. Any other known mechanisms for draining water from water trap 102 when a water level within water trap 102 reaches a predetermined level may be employed. In one known example, process 300 may then proceed to step 310.

In step 310, a portion of water may be received in secondary reservoir 116. For example, secondary reservoir 116 may receive water drained from primary reservoir 104, as described above. Accordingly, secondary reservoir 116 may generally serve as a buffer between primary reservoir 104 and water treatment locations 126. Further, secondary reservoir 116 may be provided with a secondary drain aperture 118 which is sized to appropriately meter flow of water into water passages 134. Process 300 may then proceed to step 312.

In step 312, the portion of water drained from water trap 102 is received at a water treatment location 126. For example, as described above, water may be received at air intake 126a, exhaust system 126b, air cleaner 126c, or windshield bottle 126d. Any other device or location in a vehicle which uses a supply of water during operation of the vehicle may be used in place of, or in addition to, any of the water treatment locations specifically described herein.

Accordingly, a system 100 and a process 300 for collecting water removed from a fuel supply in a water trap 102 are disclosed. Conveniently, water may be exhausted from water trap 102 to selectively and/or automatically provide water to one or more water treatment locations 126. System 100 and method 300 thereby allow for automatic disposal of water accumulated from a fuel supply.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A water trap for a water treatment system for a vehicle comprising:
a primary reservoir;
a drain in fluid communication with said primary reservoir; and
a controller for said drain, said controller operable to selectively exhaust a quantity of water from said primary reservoir to a water treatment location located on the vehicle.

2. The water trap of claim 1, further comprising a secondary reservoir having a volume less than a volume of said primary reservoir.

3. The water trap of claim 1, further comprising a heating mechanism disposed within said primary reservoir operable to heat one of the water contained within said primary reservoir and fuel associated with the water treatment system.

4. The water trap of claim 1, wherein said drain is located at a lower bottom surface of said primary reservoir.

5. The water trap of claim 1, wherein said drain includes one of a solenoid and an actuator.

6. The water trap of claim 1, wherein said controller is an electronic control module for a vehicle, said electronic control module automatically metering water to at least one water treatment location in the vehicle.

7. The water trap of claim 1, further comprising at least one sensor operable to determine a quantity of water present in said primary reservoir.

8. The water trap of claim 1, further comprising a display operable to provide a notification to a user that a water level of said primary reservoir exceeds a predetermined amount.

9. A system for removing water from fuel, comprising:
a water trap including a primary reservoir, a drain in fluid communication with said primary reservoir, and a controller for said drain;
a water passage in fluid communication with said drain; and
at least one water treatment location in fluid communication with said passage;
wherein said controller is operable to selectively exhaust a quantity of water from said primary reservoir to said at least one water treatment location.

10. The system of claim 9, further comprising a secondary reservoir in fluid communication with said primary reservoir and said water passage, said secondary reservoir having a volume less than a volume of said primary reservoir.

11. The system of claim 9, wherein said primary reservoir is one of a blow-molded reservoir and a molded reservoir.

12. The system of claim 9, further comprising a heating element disposed within said primary reservoir operable to heat one of water contained within said primary reservoir and fuel associated with the system.

13. The system of claim 9, further comprising a hydrophobic media for accumulating water in said primary reservoir.

14. The system of claim 9, wherein said drain is located at a bottom surface of said primary reservoir.

15. The system of claim 9, wherein said drain includes one of a solenoid valve and an actuator.

16. The system of claim 9, wherein said controller is an electronic control unit for a vehicle, said electronic control unit automatically metering water to at least one water treatment location in the vehicle.

17. The system of claim 9, wherein said at least one water treatment location includes at least one of an engine air cleaner, an engine air intake, an exhaust component, and a windshield washer fluid reservoir.

18. The system of claim 9, wherein said at least one water treatment location includes multiple water treatment locations, each water treatment location selectively receiving water at one of varying rates and times as compared to another water treatment location.

19. The system of claim 9, further comprising a tip disposed in said water passage adjacent said at least one water treatment location, said tip having a diameter configured to meter flow of water to said at least one water treatment location.

20. The system of claim 9, further comprising an aperture disposed in said water passage, said aperture disposed adjacent a relatively low pressure area of the vehicle to draw water from said water trap to said at least one water treatment location.

21. The system of claim 9, further comprising a material disposed in said water passage, said material operable to provide a capillary effect to water received from said water trap.

22. The system of claim 9, further comprising at least one sensor operable to determine a quantity of water present in said primary reservoir.

23. The system of claim 9, further comprising a display operable to provide a notification to a user that a water level of said primary reservoir exceeds a predetermined amount.

24. A method, comprising:
accumulating a quantity of water removed from a fuel supply in a primary reservoir;
selectively draining a portion of said quantity of water from said primary reservoir; and
receiving said portion of said quantity of water at a water treatment location in a vehicle.

25. The method of claim 24, further comprising receiving said portion of said quantity of water in a secondary reservoir having a volume less than a volume of said primary reservoir.

26. The method of claim 24, said at least one water treatment location including at least one of an engine air cleaner, and engine air intake, an exhaust pipe, an exhaust muffler, and a windshield washer fluid reservoir.

27. The method of claim 24, further comprising determining a quantity of water present in said primary reservoir.

28. The method of claim 27, further comprising notifying a user when said quantity of water present in said primary reservoir exceeds a predetermined amount.
